(19) United States
(12) Patent Application Publication
(10) Pub. No.: US 2016/0217628 A1
(43) Pub. Date: Jul. 28, 2016

(54) METHOD AND APPARATUS FOR ON-BOARD/OFF-BOARD FAULT DETECTION

(71) Applicant: GM GLOBAL TECHNOLOGY OPERATIONS LLC, DETROIT, MI (US)

(72) Inventors: YOUSSEF A. GHONEIM, ROCHESTER, MI (US); MARK N. HOWELL, ROCHESTER HILLS, MI (US)

(21) Appl. No.: 14/423,816

(22) PCT Filed: Aug. 29, 2012
(86) PCT No.: PCT/US12/52771

§ 371 Date: Feb. 25, 2016

(51) Int. Cl. G07C 5/08; G07C 5/02; G07C 5/00

(52) U.S. Cl. CPC G07C 5/0808; G07C 5/008; G07C 5/02

(57) ABSTRACT

A vehicle includes a plurality of subsystems that are monitored during on-going operation. A method for monitoring a subsystem includes monitoring states of commanded and observed parameters for the subsystem. Deviations in the observed parameters are determined off-board the vehicle. The deviations are employed to determine magnitudes of subsystem operating signatures off-board the vehicle. The subsystem operating signatures are employed to identify presence of a subsystem fault and isolate the subsystem fault off-board the vehicle. The presence of the isolated fault is communicated to the vehicle.

### TECHNICAL FIELD

This disclosure is related to vehicle systems, including monitoring, diagnostics and fault detection.

### BACKGROUND

The statements in this section merely provide background information related to the present disclosure. Accordingly, such statements are not intended to constitute an admission of prior art

On-board monitoring systems execute algorithms that monitor states of parameters to detect presence of a fault and identify a location of any detected fault. On-board monitoring systems are constrained by available memory space, communications, and execution resources in on-board controllers. Known on-board systems permit communications between vehicle systems and remote facilities.

Known diagnostic techniques for a vehicle subsystem, e.g., a fuel system rely on knowledge of prior fault conditions to diagnose and repair a fault. For example, when servicing the vehicle, a maintenance technician may determine by direct testing or review of a recorded diagnostic code that there is a fault in a fuel pump requiring repair or replacement. This reactive diagnosis may not occur until vehicle performance has already been compromised.

### SUMMARY

A vehicle includes a plurality of subsystems that are monitored during on-going operation. A method for monitoring a subsystem includes monitoring states of commanded and observed parameters for the subsystem. Deviations in the observed parameters are determined off-board the vehicle. The deviations are employed to determine magnitudes of subsystem operating signatures off-board the vehicle. The subsystem operating signatures are employed to identify presence of a subsystem fault and isolate the subsystem fault off-board the vehicle. The presence of the isolated fault is communicated to the vehicle.

### BRIEF DESCRIPTION OF THE DRAWINGS

One or more embodiments will now be described, by way of example, with reference to the accompanying drawings, in which:

FIG. 1 illustrates a vehicle signally connected to a remote subsystem monitoring system via a wireless communication transmission system, in accordance with the disclosure;

FIG. 2 illustrates an electronic returnless fuel subsystem configured to deliver pressurized fuel to an internal combustion engine, in accordance with the disclosure;

FIG. 3-1 illustrates data including pump current in relation to fuel pressure for a plurality of pump voltage commands during operation of an electronic returnless fuel system (RFS) under standardized ambient conditions, in accordance with the disclosure;

FIG. 3-2 illustrates data including pump speed in relation to fuel pressure for a plurality of pump voltage commands during operation of an electronic returnless fuel system (RFS) under standardized ambient conditions, in accordance with the disclosure;

FIG. 3-3 illustrates data including fuel pressure in relation to pump current for a plurality of pump voltage commands during operation of an electronic returnless fuel system (RFS) under standardized ambient conditions, in accordance with the disclosure;

FIGS. 4-1 through 4-5 illustrate raw data associated with operating an embodiment of an electronic returnless fuel system (RFS), including pump speed (rad/sec), pump voltage (V), commanded pressure (kPa), actual pressure (kPa), pump flowrate (L/h), and pump current (A), in accordance with the disclosure; and

FIGS. 5-1 through 5-5 illustrate normalized subsystem operating signatures associated with operation of an electronic returnless fuel system (RFS) that correspond to the raw data shown with reference to FIGS. 4-1 through 4-5, respectively, in accordance with the disclosure.

### DETAILED DESCRIPTION

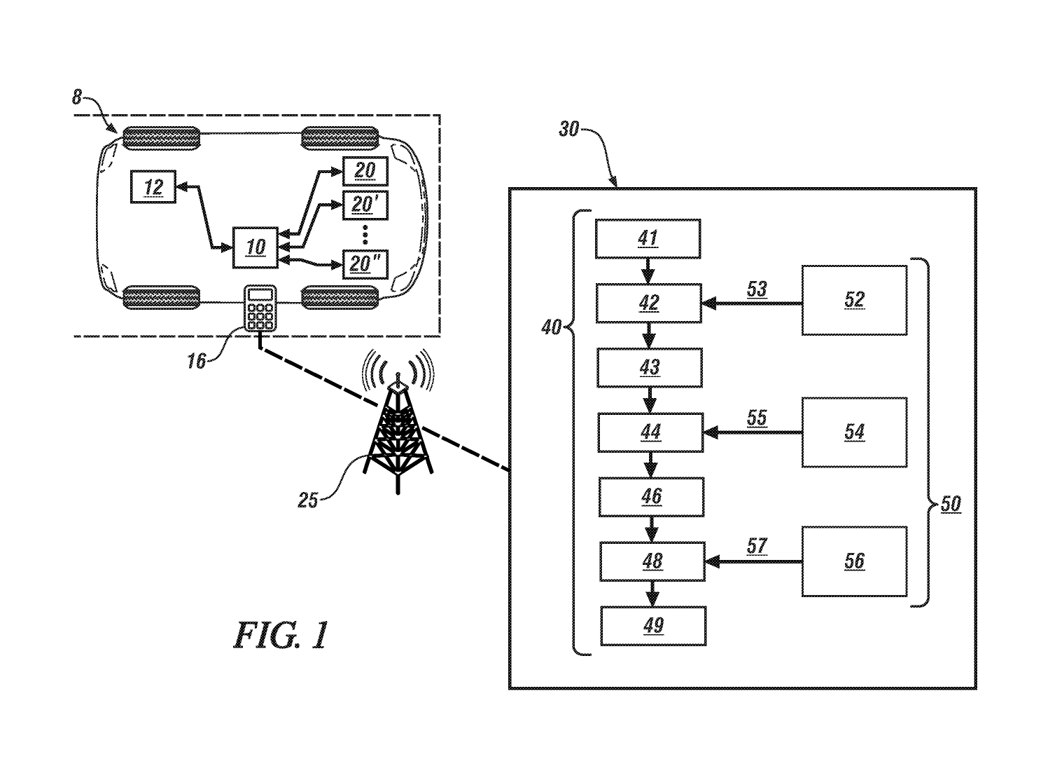

Referring now to the drawings, wherein the showings are for the purpose of illustrating certain exemplary embodiments only and not for the purpose of limiting the same, FIG. 1 schematically illustrates a vehicle 8 signally connected to a remote subsystem monitoring system 30 via a wireless communication transmission system 25. The vehicle 8 may include any vehicle, and in one embodiment is a passenger vehicle providing ground transportation. The vehicle 10 preferably has a propulsion system that converts energy to torque to provide propulsion power to one or more vehicle wheels.

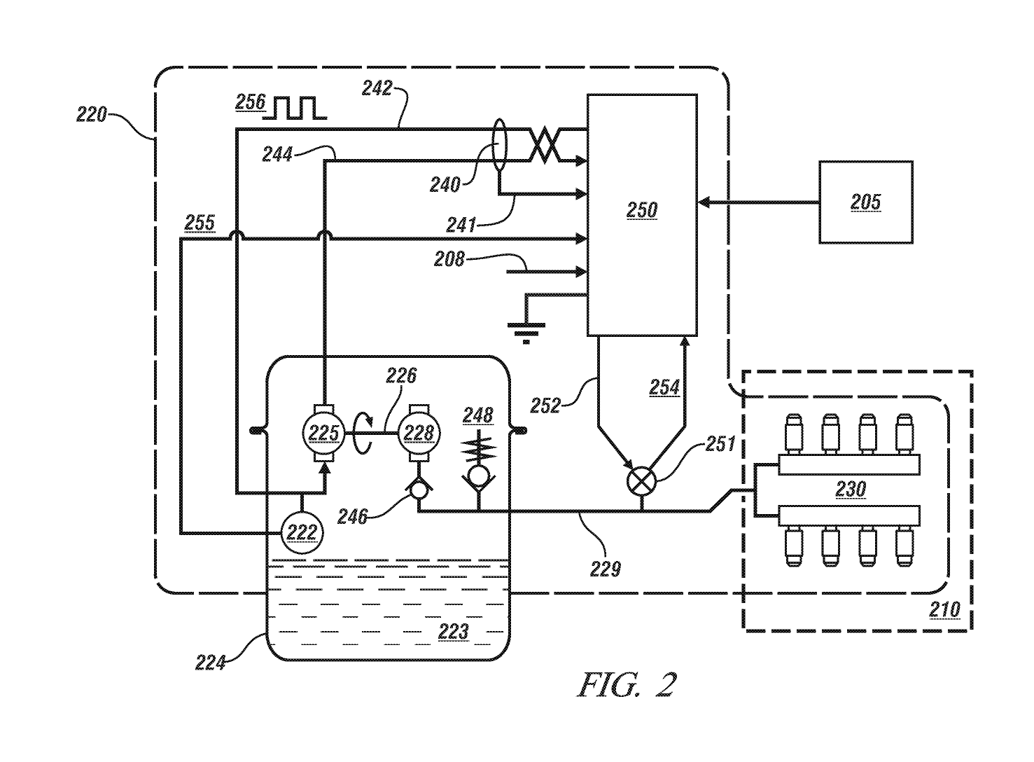

The vehicle 8 includes a controller 10 that signally and operatively connects to a plurality of subsystems 20, 20′, . . . 20″, an extra-vehicle communications system 16, and a human/machine interface (HMI) device 12. The subsystems 20, 20′, . . . 20″ preferably include devices and associated control elements that provide various vehicle functions including, e.g., functions related to vehicle propulsion, ride/handling, and HVAC, among others. One of the subsystems 20 is a returnless fuel management system described herein with reference to FIG. 2. The HMI device 12 preferably includes a visual display system, e.g., a multi-function dashboard that is employed to communicate vehicle operating information to a vehicle operator. The HMI device 12 includes a malfunction indicator lamp (MIL) and related information for communicating presence of an on-board fault to the operator.

The vehicle 8 includes a wireless communications system 16 configured to effect extra-vehicle communications, including communication via the wireless communication transmission system 25 to the remote subsystem monitoring system 30. In one embodiment, the wireless communications system 16 includes a wireless telematics communications system capable of short-range wireless communications to a handheld device, e.g., a cellular phone. In one embodiment the handheld device is loaded with a software application that includes a wireless protocol to communicate with the controller 10, and the handheld device executes the extra-vehicle communications, including communication to the remote subsystem monitoring system 30 via the wireless communication transmission system 25.

The controller 10 regularly communicates with the remote subsystem monitoring system 30. Information communicated from the controller 10 includes parametric data representing operation of one or a plurality of the subsystems 20, 20′, . . . 20″ and vehicle identification information including vehicle identification information in the form of vehicle make, model, model year, VIN, and/or other pertinent data.

The remote subsystem monitoring system 30 preferably includes an off-board control scheme 40 and an off-line control scheme 50 configured to provide data management and analytical functions associated with detecting and isolating a fault in one or a plurality of the subsystems 20, 20′, . . . 20″. Table 1 is provided as a key to remote subsystem monitoring system 30 of FIG. 1, wherein the numerically labeled blocks and the corresponding functions of the off-board control scheme 40 and the off-line control scheme 50 are set forth as follows.

TABLE 1

| BLOCK | BLOCK CONTENTS |
|---|---|
| 40 | Off-board control scheme |
| 41 | Monitor parametric data representing operation of the |
| | subsystems 20, 20′, . . . 20″ |
| 42 | Determine expected states for the observed parameters based |
| | upon the commanded parameter employing system models |
| 43 | Compare expected states for the observed parameters to |
| | corresponding observed states to calculate deviations |
| 44 | Employ deviations to calculate subsystem operating |
| | signatures \hat{T}₁, \hat{T}₂, . . . \hat{T}_{N} |
| 46 | Normalize subsystem operating signatures to T1, T2, . . . TN |
| 48 | Compare normalized operating signatures to corresponding |
| | thresholds in a subsystem fault isolation matrix |
| 49 | Communicate presence (or absence) of a subsystem fault |
| 50 | Off-Line control scheme |
| 52 | Characterize one of the subsystems |
| 54 | Execute a training algorithm to determine weighting |
| | vector(s) for the subsystem operating signatures \hat{T}₁, \hat{T}₂, . . . |
| | \hat{T}_{N} that are associated with specific subsystem faults |
| 56 | Determine a fault threshold scheme that employs the |
| | subsystem operating signatures \hat{T}₁, \hat{T}₂, . . . \hat{T}_{N} to isolate |
| | subsystem faults. |

The off-line control scheme 50 includes operations that can be executed at any time, including operations that are executed prior to deploying a specific vehicle line, operations that are executed prior to deploying a specific vehicle, and operations that are executed coincident with deployment of a specific vehicle line and a specific vehicle. The off-line control scheme 50 can operate when a specific vehicle is in an off state, or when a specific vehicle is operating. The off-line control scheme 50 supplies information to the off-board control scheme 40 to enable the off-board control scheme 40 to provide functionality to a subject vehicle, e.g., vehicle 8. The information supplied to the subject vehicle by the off-line control scheme 50 may be refreshed and updated to reflect changes associated with learned information.

The off-line control scheme 50 includes a scheme for characterizing a selected one of the subsystems 20 (52). Characterizing a subsystem includes developing relationships between commanded and observed parameters of the subject subsystem by testing the subject subsystem under known operating and ambient conditions, and gathering and analyzing data associated therewith. By way of example, an electric motor can be characterized in terms of electrical voltage, electrical current, rotational position and/or speed, torque or load, and ambient temperature. When the electric motor is employed to power a fluidic pump as part of the subsystem 20, hydraulic pressure may be substituted in place of the torque or load. The relationships between the commanded parameter of electrical voltage and observed parameters of electrical current, rotational position and/or speed, torque or load, and ambient temperature are used as the basis for one or more system models 53. A person having ordinary skill in the art is able to characterize other subsystems to develop relationships between commanded parameters and observed parameters of interest.

A plurality of subsystem operating signatures \hat{T}₁, \hat{T}₂, . . . \hat{T}_{N} are developed, and represent analytical parameters associated with changes in one of the observed parameters. The subsystem operating signatures \hat{T}₁, \hat{T}₂, . . . \hat{T}_{N} can be employed to detect a subsystem fault based upon changes from a nominal operating state in the observed parameter while the subsystem is operating in response to a known command. When the subsystem includes a fluidic pump, the subsystem operating signatures \hat{T}₁, \hat{T}₂, . . . \hat{T}_{N} can be associated with changes in observed parameters including pump speed, fluidic pressure, and electrical current from the corresponding nominal operating states when the fluidic pump is operating at a commanded voltage (e.g., a pulsewidth-modulated voltage).

The off-line control scheme 50 includes a scheme for executing a training algorithm that determines weighting vector(s) 55 for one or more of the subsystem operating signatures \hat{T}₁, \hat{T}₂, . . . \hat{T}_{N} that are associated with subsystem faults for the selected subsystem 20 (54). This includes initially identifying and isolating the subsystem faults that affect operation or performance of the subsystem 20. The subsystem faults of interest are those that affect performance of the subsystem, or affect operation of a related system. A fault isolation database is developed that includes the commanded and observed parameters, e.g., electrical voltage, electrical current, rotational position and/or speed, and torque or load, in relation to one or more of the subsystem faults. The specific subsystem faults can be identified using experiential knowledge, failure-mode effects analyses, and other methods. Developing the fault isolation database can include inducing magnitudes of one of the faults in a known system and monitoring and collecting data for the parameters of interest. The training algorithm determines the weighting vectors 55 for each induced subsystem fault for the selected subsystem 20 using the fault isolation database. In one embodiment, the training algorithm employs statistical analysis tools such as linear discriminant analysis to find linear combinations of the parameters of the fault isolation database that characterize or separate two or more classes of events. The linear discriminant analysis tool analyzes the data to develop dependent variables that are categorical in nature, such as the subsystem faults. The linear discriminant analysis tool seeks combinations of independent variables, i.e., the parameters of interest, that best explain the data. The independent data represented by the parameters of interest are variable in nature, whereas the dependent terms, i.e., the subsystem faults, are categorical in nature. One or more weighting vectors 55 for the selected subsystem 20 can be determined by employing the linear discriminant analysis tool to analyze the data of the fault isolation database. An illustration of results of use of the linear discriminant analysis tool is described herein with reference to EQ. 6.

The off-line control scheme 50 includes a scheme for determining a fault threshold scheme that employs the subsystem operating signatures \hat{T}₁, \hat{T}₂, . . . \hat{T}_{N} to isolate subsystem faults (56). The magnitudes of the subsystem operating signatures \hat{T}₁, \hat{T}₂, . . . \hat{T}_{N} can indicate an absence of any fault, or presence of a specific one of the subsystem faults. The fault threshold scheme (56) develops a fault isolation matrix 57 that is deployed for use in identifying and isolating subsystem faults.

The off-board control scheme 40 includes operations that are executed in response to operation of the subject vehicle to provide real-time analytical support to the subject vehicle. Preferably the operations that are executed in response to operation of the subject vehicle are coincident with operation of the subject vehicle.

The off-board control scheme 40 monitors the parametric data communicated from the controller 10 of the vehicle 8 representing operation of the subsystems 20, 20′, . . . 20″ (41). The following describes operation of the off-board control scheme 40 for one of the subsystems 20. It is appreciated that the off-board control scheme 40 is configured to operate in a similar manner for each of the subsystems 20, 20′, . . . 20″. The parametric data for the subsystem includes a first dataset and a second dataset, wherein the first dataset includes a commanded parameter, e.g., a pulsewidth-modulated (PWM) voltage command, and the second dataset includes observed parameters, including e.g., rotational speed, current, and pressure.

The off-board control scheme 40 employs the system models 53 to determine expected states for the observed parameters based upon the commanded parameter (42). The expected states for the observed parameters are each compared to corresponding observed states for the observed parameters to calculate deviations from the expected states (43). The deviations from the expected states are employed to calculate the subsystem operating signatures \hat{T}₁, \hat{T}₂, . . . \hat{T}_{N} (44), which are normalized to T1, T2, . . . TN (46). Normalizing the subsystem operating signatures \hat{T}₁, \hat{T}₂, . . . \hat{T}_{N} is conducted to remove relative magnitudes of the various parameters from the analysis, and includes calculating for each of the subsystem operating signatures as follows:

Ti=\hat{T}ᵢ/max(\hat{T}ᵢ) [1]

wherein Ti represents a normalized subsystem operating signature for operating signatures ranging from i=1 . . . n.

The normalized operating signatures T1, T2, . . . TN are compared to corresponding thresholds in the fault isolation matrix 57 to detect absence of a subsystem fault or to detect presence of a subsystem fault and isolate a location and/or a source of the subsystem fault (48). The off-board control scheme 40 communicates presence (or absence) of the subsystem fault to the controller 10 of the vehicle 8 (49), and the controller 10 is able to notify the vehicle operate of the presence (or absence) of the subsystem fault using the HMI device 12.

FIG. 2 schematically depicts an embodiment of one of the subsystems 20, which is an electronic returnless fuel system (RFS) 220 configured to deliver pressurized fuel to an internal combustion engine 210 via a fuel rail 230 that is in fluid communication with engine fuel injectors. The RFS 220 is preferably configured to operate at high pressure, which may be in the range of 10-20 MPa in one embodiment. The RFS 220 is employed on a fuel tank 224 containing a supply of fuel 223 such as gasoline, ethanol, E85, or other combustible fuel. The fuel tank 224 is sealed relative to the surrounding environment and lacks a fuel return line from the fuel rail 230. The internal combustion engine 210 may be employed on a vehicle to provide torque for tractive power generation and/or electric power generation.

The RFS 220 includes a fuel pump 228, an electrically-powered pump motor 225 and a RFS controller 250, and employs other components, elements and systems as described herein. The fuel pump 228 and pump motor 225 are disposed within the fuel tank 224 and preferably submerged in fuel 223 contained therein. The pump motor 225 electrically connects to the RFS controller 250 via control line 242, with a ground path 244 returning thereto. The pump motor 225 generates and transfers mechanical power via a rotating pump shaft 226 to the fuel pump 228 in response to a pump motor control signal 256 from the RFS controller 250. The fuel pump 228 fluidly connects to the fuel rail 230 via a fuel line 229 to provide pressurized fuel to injectors of the engine 10. The fuel pump 228 is operable to pump fuel 223 to the fuel rail 230 for distribution into the internal combustion engine 10 in response to the pump motor control signal 256. The fuel pump 228 is preferably a roller vane pump or gerotor pump, and may be any suitable pump element. A fuel pressure sensor 251 is employed to monitor fuel pressure 254 in the fuel line 229. A current sensor 222 is configured to monitor electrical current 255 supplied to the pump motor 225 via control line 242. The fuel tank 224 further includes a check valve 246 and a pressure vent valve 248 disposed therein along the fuel line 229. The fuel pump 228 is electrically grounded via a ground path 244 from the pump motor 225 that includes a grounding shield 240 having a ground shield input 241 to RFS controller 250.

The RFS controller 250 signally couples to an engine control module (ECM) 205. The RFS controller 250 operatively connects to the pump motor 225 via control line 242 and signally connects to the fuel pressure sensor 251 and the current sensor 222. The RFS controller 250 generates the pump motor control signal 256 to control the pump motor 225 to operate the fuel pump 228 to achieve and/or maintain a desired fuel system pressure in response to commands from the ECM 205. The RFS controller 250 provides a reference voltage 252 to the pressure sensor 251 and monitors signal outputs from the pressure sensor 251 to determine the fuel pressure 254. The RFS controller 250 monitors the electrical current 255 and the fuel pressure 254 for feedback control and diagnostics.

The pump motor control signal 256 is a pulsewidth-modulated (PWM) voltage signal in one embodiment that is communicated via control line 242 to operate the fuel pump 228. The pump motor control signal 256 provides pulsed electrical energy to the pump motor 225 in the form of a rectangular pulse wave. The pump motor control signal 256 is modulated by the RFS controller 250 resulting in a particular variation of an average value of the pulse waveform. Energy for the pump motor control signal 256 can be provided by a battery, e.g., a DC chemical-electrical energy storage system that supplies a battery input 208 to the RFS controller 250. By modulating the pump motor control signal 256 using the RFS controller 250, energy flow to the pump motor 225 is regulated to control the fuel pump 228 to achieve a desired fuel system pressure for the fuel supplied to the fuel rail 230. The RFS 220 described herein is meant to be illustrative of one subsystem 20.

As previously mentioned, the fuel pump 228 and pump motor 225 are disposed within the fuel tank 224. The pump motor 225 is preferably a brush-type electric motor or another suitable electric motor that provides mechanical power via a rotating pump shaft 226 to the fuel pump 228. The fuel pump 228 propels fuel into the fuel line 229 to the fuel rail 230, thereby generating pressurized fuel in the fuel line 229 and the fuel rail 230, with the fuel pressure 254 monitored by the RFS controller 250 using the pressure sensor 251.

The RFS controller 250 controls the fuel pump 228 to achieve and/or maintain the desired fuel system pressure by applying closed-loop correction derived from the monitored fuel pressure 254 measured by the pressure sensor 251 and the monitored pump current 255 measured by the current sensor 222 as feedback. Further, the pump motor control signal 256 is monitored by the RFS controller 250. Thus, the pump parameters preferably include observed parameters including the fuel pressure 254 and the pump current 255, and commanded pump parameters including the pump motor control signal 256 when the RFS 220 is deployed on-vehicle.

Control module, module, control, controller, control unit, processor and similar terms mean any one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs or routines, combinational logic circuit(s), input/output circuit(s) and devices, appropriate signal conditioning and buffer circuitry, and other components to provide the described functionality. Software, firmware, programs, instructions, routines, code, algorithms and similar terms mean any controller executable instruction sets including calibrations and look-up tables. The control module has a set of control routines executed to provide the desired functions. Routines are executed, such as by a central processing unit, and are operable to monitor inputs from sensing devices and other networked control modules, and execute control and diagnostic routines to control operation of actuators. Routines may be executed at regular intervals, for example each 3.125, 6.25, 12.5, 25 and 100 milliseconds during ongoing engine and vehicle operation. Alternatively, routines may be executed in response to occurrence of an event.

As described with reference to FIG. 1, the off-line control scheme 50 includes schemes for characterizing a selected one of the subsystems 20 (52), executing a training algorithm that determines weighting vector(s) 55 for one or more of the subsystem operating signatures \hat{T}₁, \hat{T}₂, . . . \hat{T}_{N} that are associated with specific faults for the selected subsystem 20 (54), and determining a fault threshold scheme that employs the subsystem operating signatures \hat{T}₁, \hat{T}₂, . . . \hat{T}_{N} to isolate subsystem faults (56).

Characterizing a subsystem includes developing relationships between commanded and observed parameters of interest by experimentally testing the subsystem under known operating and ambient conditions, and gathering and analyzing data associated therewith. Thus, characterizing the RFS 220 includes experimentally determining observable operating parameters of the RFS 220, including current, pump speed, and system pressure in response to the commanded voltage. System models are generated off-line that can be employed to determine expected states for the observed parameters based upon the commanded parameter. These are the system models 53 described with reference to FIG. 1.

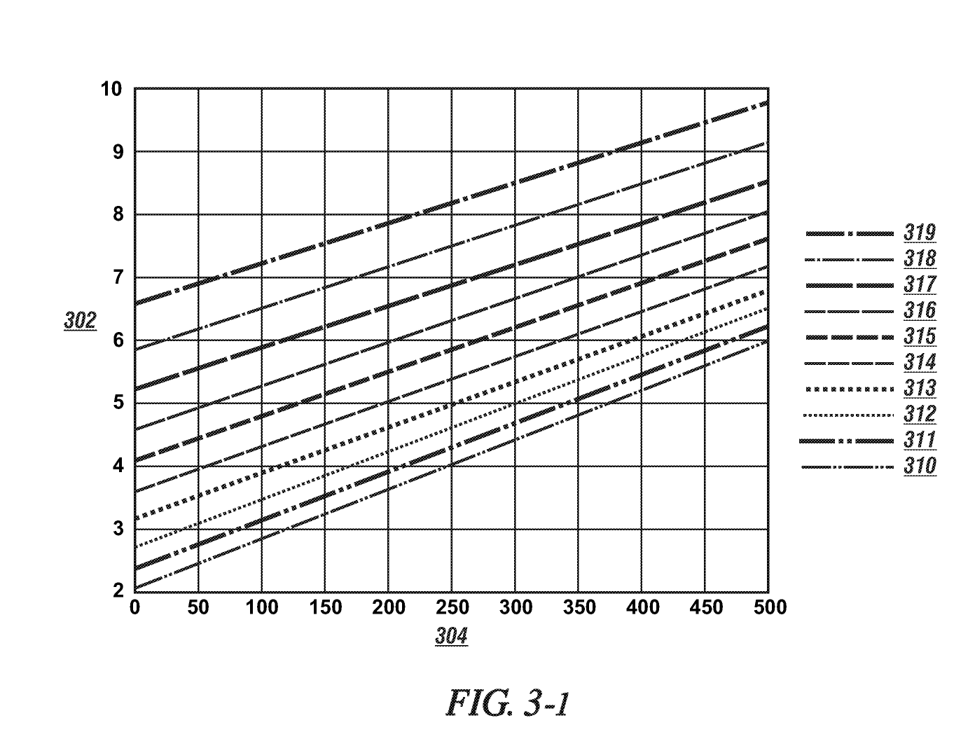

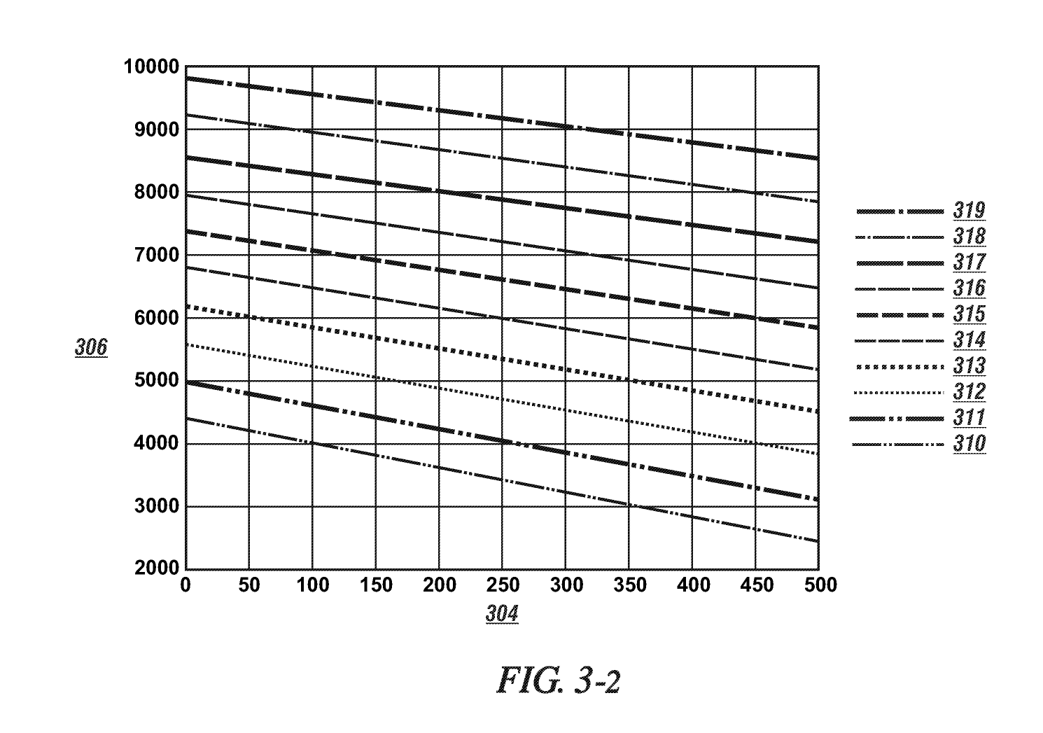

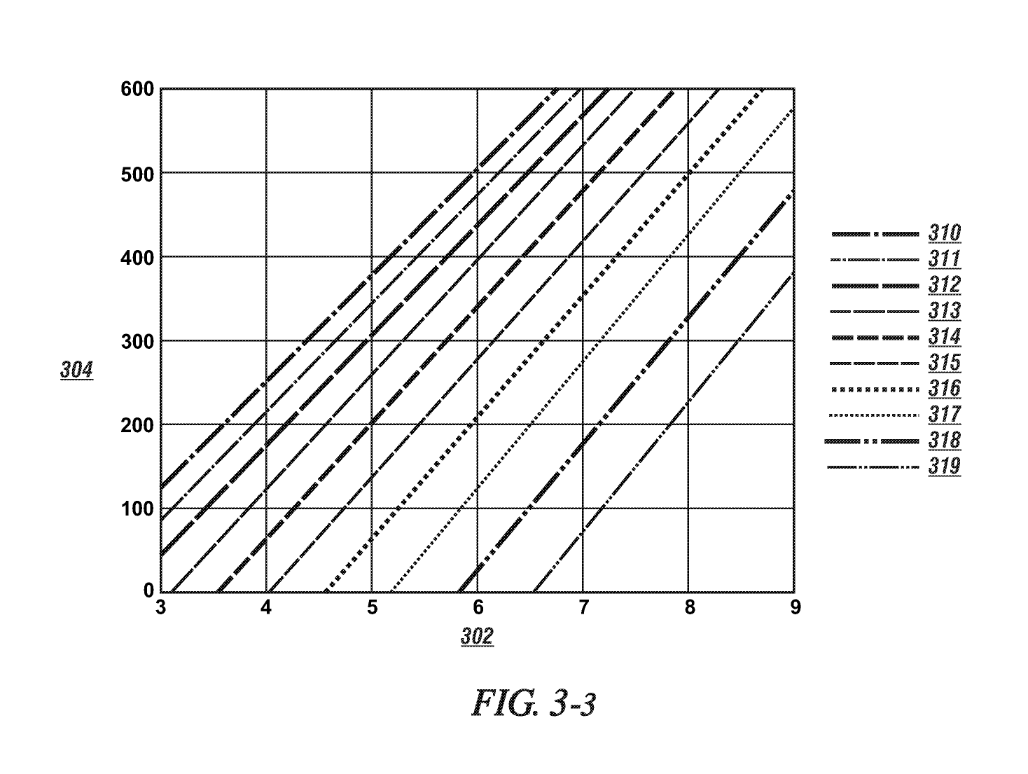

FIG. 3-1 graphically shows data including pump current in relation to fuel pressure for a plurality of pump voltage commands during operation of an embodiment of the RFS 220 under standardized ambient conditions. The pump current is indicated by signal outputs from the current sensor 222, which is shown on the vertical axis 302. The system pressure is indicated by signal outputs from the fuel pressure sensor 251 shown on the horizontal axis 304. Depicted pump motor control signals 256 have equivalent pump voltages of 6 V (310), 7 V (311), 8 V (312), 9 V (313), 10 V (314), 11 V (315), 12 V (316), 13 V (317), 14 V (318), and 15 V (319). A relationship between the pump current, system pressure, and pump voltage can be developed, as follows.

Iₘ=aᵢ(V)Pₛ+bᵢ(V) [2]

wherein Iₘ is expected pump current;
Pₛ is system pressure;
V is pump voltage; and
aᵢ and bᵢ are system-specific scalar values that are experimentally and analytically determined.
   The relationship of EQ. 2 is one of the system models 53 that can be employed to determine an expected pump current based upon the commanded pump voltage and the monitored system pressure.

FIG. 3-2 graphically shows data including pump speed in relation to fuel pressure for a plurality of pump voltage commands during operation of an embodiment of the RFS 220 under standardized ambient conditions. The pump speed is indicated by signal outputs from a rotational sensor, which is shown on the vertical axis 306. The pump speed may be directly measured using a rotational speed sensor or estimated based upon a predetermined speed relationship based upon the pump voltage, pump current and fuel pressure during off-line characterization of an embodiment of the RFS 220. The system pressure is indicated by signal outputs from the fuel pressure sensor 251 shown on the horizontal axis 304. Depicted pump motor control signals 256 have equivalent pump voltages of 6 V (310), 7 V (311), 8 V (312), 9 V (313), 10 V (314), 11 V (315), 12 V (316), 13 V (317), 14 V (318), and 15 V (319). A relationship between the pump speed, system pressure, and pump voltage can be developed, as follows:

ωₘ=a_{ω}(V)Pₛ+b_{ω}(V) [3]

wherein ωₘ is expected pump rotational speed;
Pₛ is system pressure;
V is pump voltage; and
a_{ω} and b_{ω} are system-specific scalar values that are experimentally and analytically determined.
   The relationship of EQ. 3 is another one of the system models 53 that can be employed to determine a modeled or expected pump speed based upon the commanded pump voltage and the monitored system pressure.

FIG. 3-3 graphically shows data including fuel pressure in relation to pump current for a plurality of pump voltage commands during operation of an embodiment of the RFS 220 under standardized ambient conditions. The pump current is indicated by signal outputs from the current sensor 222, which is shown on the vertical axis 302. The system pressure is indicated by signal outputs from the fuel pressure sensor 251 shown on the horizontal axis 304. Depicted pump motor control signals 256 have equivalent pump voltages of 6 V (310), 7 V (311), 8 V (312), 9 V (313), 10 V (314), 11 V (315), 12 V (316), 13 V (317), 14 V (318), and 15 V (319). A relationship between the system pressure and the pump current and pump voltage can be developed, as follows:

$${P}_{m} = \frac{{I}_{s} - {b}_{i} ( V )}{{a}_{i} ( V )} \qquad [ 4 ]$$

wherein Pₘ is expected system pressure;
Iₛ is pump current;
V is pump voltage; and
aᵢ and bᵢ are system-specific scalar values that are experimentally and analytically determined.
   The relationship of EQ. 4 is another one of the system models 53 that can be employed to determine a modeled or expected system pressure based upon the commanded pump voltage and the monitored pump current.

The off-board control scheme 40 employs the system models 53 to determine expected states for the observed parameters based upon the commanded parameter, as previously described with reference to FIG. 1 (42). Thus, for the RFS 220, the system models 53 provided to the off-board control scheme 40 include EQS. 2, 3, and 4, which are employed to determine expected states for the pump current (Iₘ), pump rotational speed (ωₘ), and system pressure (Pₘ) based upon the commanded pump voltage.

The off-board control scheme 40 compares the expected states for the observed parameters of pump current (Iₘ), pump rotational speed (ωₘ), and system pressure (Pₘ) to corresponding observed states of pump current (Iₛ), pump rotational speed (ωₘ_{_}_{obs}), and system pressure (Pₛ) to calculate deviations from the expected states (43). The RFS 220 may directly monitor the pump rotational speed of the fuel pump 228, or alternatively, the RFS 220 may be configured to estimate the pump speed of the fuel pump 228 based upon a predetermined speed relationship based upon the pump voltage, pump current and fuel pressure. The current deviation (ΔI), speed deviation (Δω) and pressure deviation (ΔP) are calculated as follows.

ΔI=Iₛ−Iₘ

Δω=ωₘ_{_}_{obs}−ωₘ

ΔP=Pₛ−Pₘ [5]

The aforementioned deviations are employed to calculate magnitudes of subsystem operating signatures \hat{T}₁, \hat{T}₂, . . . \hat{T}_{N} using the weighting vector(s) 55 (44). The magnitudes of the subsystem operating signatures \hat{T}₁, \hat{T}₂, . . . \hat{T}_{N} can be associated with specific faults for the selected subsystem 20 (54). In one embodiment of the RFS 244, the subsystem operating signatures include \hat{T}₁, \hat{T}₂, and \hat{T}₃. The \hat{T}₁ signature is associated with the current deviation (ΔI), and accounts for those factors that influence electrical current. The \hat{T}₂ signature is associated with the speed deviation (Δω). The \hat{T}₃ signature is associated with the pressure deviation (ΔP).

Magnitudes of the subsystem operating signatures \hat{T}₁, \hat{T}₂, and \hat{T}₃ are calculated as follows:

\hat{T}₁=(w₁Iₛ+w₂Q+w₃Pₛ+w₄V+w₅ωₘ_{_}_{obs})(ΔI)

\hat{T}₂=Δω

\hat{T}₃=ΔP [6]

wherein Iₛ is electrical current;
Q is system mass flow;
Pₛ is system pressure;
V is system voltage;
ωₘ_{_}_{obs} is observed motor speed;
ΔI is current deviation; and
w=[w₁ w₂ w₃ w₄ w₅] is the weighting vector 55 determined off-line by the off-line control scheme 50 using linear discrimination analysis to achieve separation between a plurality of subsystem faults.
   The weighting vector 55, and the ΔI, Δω, and ΔP terms are employed to generate subsystem operating signatures including \hat{T}₁, \hat{T}₂, and \hat{T}₃ that achieve separation between the subsystem faults. Once determined, the magnitudes of the subsystem operating signatures \hat{T}₁, \hat{T}₂, and \hat{T}₃ are normalized to T1, T2, T3 (46), as previously described.

The off-line control scheme 50 provides a fault threshold scheme that employs the subsystem operating signatures \hat{T}₁, \hat{T}₂, . . . \hat{T}_{N} normalized to T1, T2, T3 to isolate subsystem faults of the RFS 220 (56). This includes developing a fault threshold set, which takes the following form in one embodiment.

Sₒ={s [symbol] εₒ<s<−εₒ}

S₊={s [symbol] ε₊<s<ε₊₊}

S₊₊={s [symbol] ε₊₊<s<ε₊₊₊}

S₊₊₊={s [symbol] ε₊₊₊≦s}

S₋={s [symbol] ε₋₋<s<ε₋}

S₋₋={s [symbol] ε₋₋₋<s<ε₋₋}

S₋₋₋={s [symbol] ε₋₋₋>s}

εₒ=0.08

ε₊=0.09

ε₊₊=0.6

ε₊₊₊=0.65

ε₋=−0.08

ε₋₋=−0.6

ε₋₋₋=−0.65 [7]

The fault threshold set shown with reference to EQ. 7 is employed to develop a fault isolation scheme for the RFS subsystem 220.

Each of the normalized subsystem operating signatures T1, T2, T3 can be represented as “s” in the fault threshold set of EQ. 7 to identify a signature attribute, which is one of Sₒ, S₊, S₊₊, S₊₊₊, S₋, S₋₋, and S₋₋₋, based upon the magnitude of the selected “s” normalized signature in relation to error thresholds identified as εₒ, ε₊, ε₊₊, ε₊₊₊, ε₋, ε₋₋, and ε₋₋₋. The magnitudes of the error thresholds εₒ, ε₊, ε₊₊, ε₊₊₊, ε₋, ε₋₋, and ε₋₋₋ set forth in EQ. 7 are meant to be illustrative, and not intended to be restrictive. The fault isolation scheme employs the normalized subsystem operating signatures T1, T2, T3 in relation to the error thresholds identified in the fault threshold set of EQ. 7 to isolate specific subsystem faults, and can take the following form in Table 2.

TABLE 2

| | | | | | Winding/ |
|---|---|---|---|---|---|
| Fault | | Pressure | Fuel | Filter | Commutator |
| Signature | No Fault | Bias | Leak | Blockage | Fault |
| T1 | Sₒ | S₊ | S₋ | Sₒ | S₋₋₋ |
| T2 | Sₒ | S₊ | S₊₊ | S₋ | S₋₋₋ |
| T3 | Sₒ | S₊₊ | S₋₋₋ | S₋₋ | S+++ |

Thus, in order to identify and isolate one of the subsystem faults, the fault thresholds for all the normalized subsystem operating signatures T1, T2, T3 must be satisfied. The off-board control scheme 40 communicates presence (or absence) of a subsystem fault to the controller 10 of the vehicle 8 (49), and the controller 10 is able to notify the vehicle operate of the presence (or absence) of the subsystem fault using the HMI device 12.

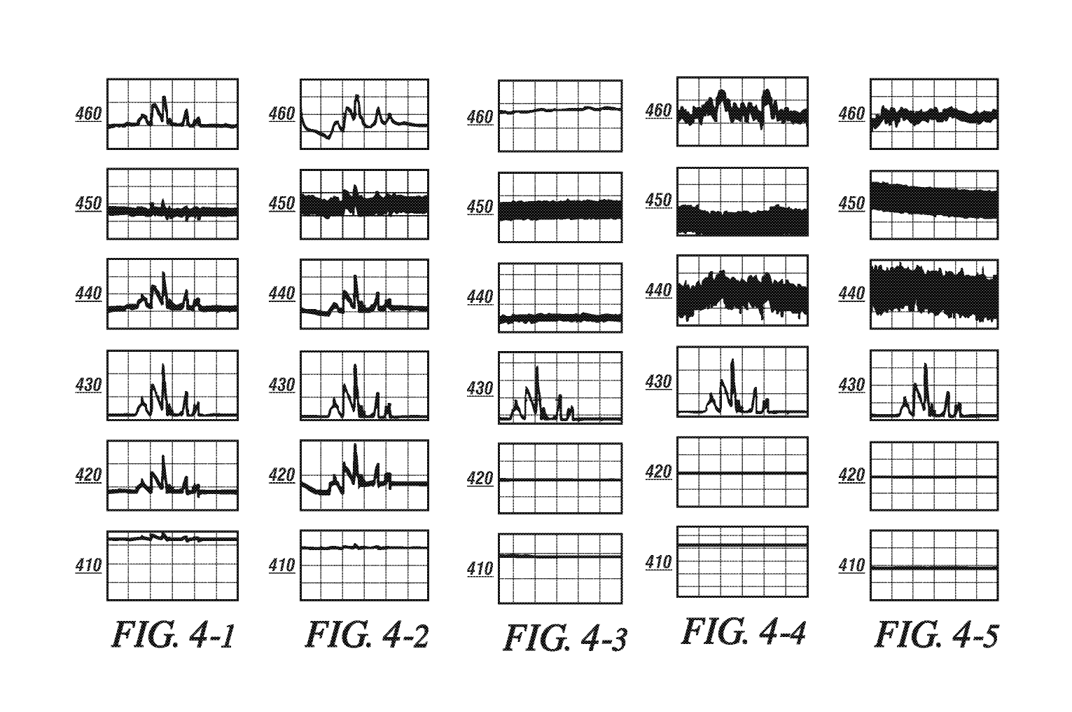

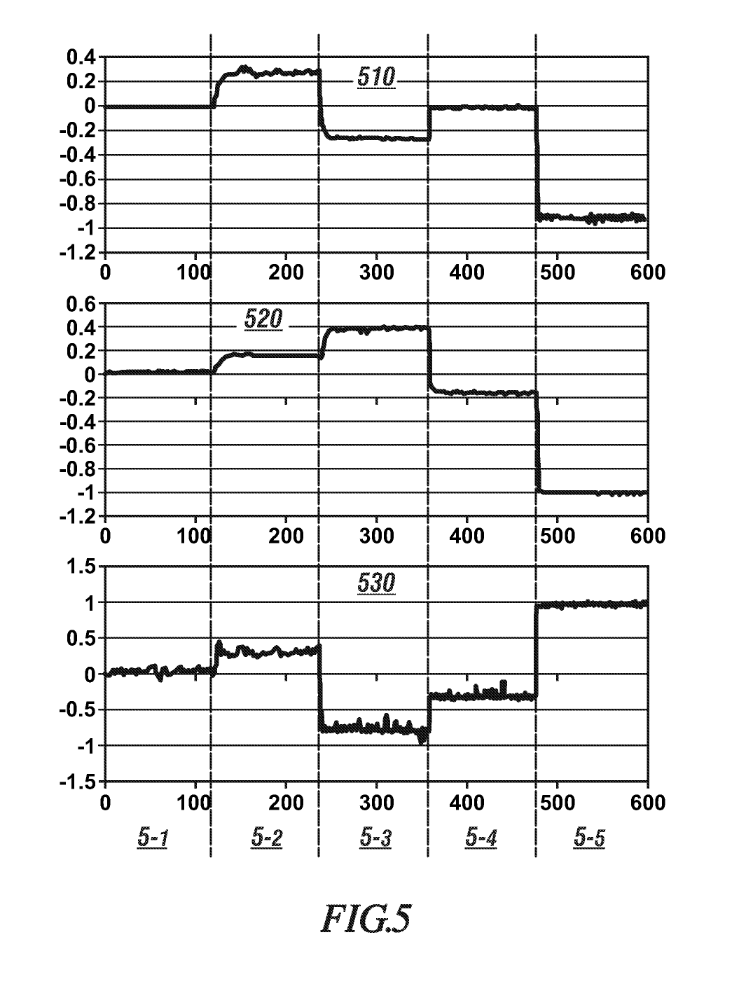

FIGS. 4-1 through 4-5 each show raw data associated with operating an embodiment of the RFS subsystem 220, including pump speed (rad/sec) 410, pump voltage (V) 420, commanded pressure (kPa) 430, actual pressure (kPa) 440, pump flowrate (L/h) 450, and pump current (A) 460. FIG. 4-1 shows the aforementioned data for an RFS subsystem 220 that is operating in compliance with system specifications. FIG. 4-2 shows the aforementioned data for the RFS subsystem 220 with a pressure sensor bias fault. FIG. 4-3 shows the aforementioned data for the RFS subsystem 220 with an in-system fuel leak. FIG. 4-4 shows the aforementioned data for the RFS subsystem 220 with a blocked fuel filter. FIG. 4-5 shows the aforementioned data for the RFS subsystem 220 with a fault in the windings or commutator of the electric motor for the fuel pump. Such data can be employed by the off-line control scheme 50 to characterize the RFS subsystem 220, including developing the system models 53 and developing the fault threshold set shown with reference to EQ. 7.

FIGS. 5-1 through 5-5 each show normalized subsystem operating signatures T1 530, T2 520, and T3 510 associated with operating an embodiment of the RFS subsystem 220 that correspond to the raw data shown with reference to FIGS. 4-1 through 4-5, respectively. FIG. 5-1 shows the normalized subsystem operating signatures T1 530, T2 520, and T3 510 for an RFS subsystem 220 that is operating in compliance with system specifications. FIG. 5-2 shows the normalized subsystem operating signatures T1 530, T2 520, and T3 510 for a pressure sensor bias fault. FIG. 5-3 shows the normalized subsystem operating signatures T1 530, T2 520, and T3 510 for an in-system fuel leak. FIG. 4-4 shows the normalized subsystem operating signatures T1 530, T2 520, and T3 510 for a blocked fuel filter. FIG. 4-5 shows the normalized subsystem operating signatures T1 530, T2 520, and T3 510 for a fault in the windings or commutator of the electric motor for the fuel pump.

### INDUSTRIAL APPLICABILITY

A vehicle can employ a fault detection and isolation system for monitoring an on-board subsystem. This includes a remote subsystem monitoring system 30 having an off-board control scheme 40 and an off-line control scheme 50 that provide data management and analytical functions associated with detecting and isolating a subsystem fault.

A model-based detector based on residuals, parity equations, regression, and parameter estimation techniques can be implemented to detect faults and estimate a state of health of a subsystem during real-time operation of the vehicle. An off-board algorithm and its corresponding parameters can be exported a back-office of a remote service center. An on-vehicle telematics system is employed for periodic/event trigger communication with the service center to establish a data collection session from the subsystem that feeds it to the off-board service center for analysis. When an on-board algorithm detects unexpected behaviors, it can communicate with the remote service center, which collects data that is analyzed by the off-board control scheme for diagnosis, detection and isolation. Vehicle service can be initiated in response to the analysis by the off-board control scheme.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A method for monitoring a subsystem for a vehicle during ongoing operation, comprising:
monitoring states of commanded and observed parameters for the subsystem;
determining deviations in the observed parameters off-board the vehicle;
employing the deviations to determine magnitudes of subsystem operating signatures off-board the vehicle;
employing the subsystem operating signatures to identify presence of a subsystem fault and isolate the subsystem fault off-board the vehicle; and
communicating the presence of the isolated fault to the vehicle.

2. The method of claim 1, wherein determining deviations in the observed parameters off-board the vehicle comprises:
executing an off-line analysis employing parametric data representing operation of the subsystem to develop a system model for the subsystem;
employing the system model to determine expected states for the observed parameters based upon the commanded parameters off-board the vehicle; and
determining deviations in the observed parameters off-board the vehicle based upon comparisons of the expected states and the monitored states for the observed parameters.

3. The method of claim 1, wherein employing the deviations to determine magnitudes of subsystem operating signatures off-board the vehicle comprises:
developing a plurality of subsystem operating signatures \hat{T}₁, \hat{T}₂, . . . \hat{T}_{N} associated with the observed parameters off-line;
executing a training algorithm that determines a weighting vector for the subsystem operating signatures \hat{T}₁, \hat{T}₂, . . . \hat{T}_{N} associated with specific faults for the selected subsystem; and
employing the weighting vector for the subsystem operating signatures \hat{T}₁, \hat{T}₂, . . . \hat{T}_{N} and the deviations in the observed parameters to determine said magnitudes of the subsystem operating signatures.

4. The method of claim 1, wherein employing the subsystem operating signatures to identify presence of a subsystem fault and isolate the subsystem fault off-board the vehicle comprises:
for each of the subsystem operating signatures, identifying a signature attribute based upon a magnitude of the respective subsystem operating signature in relation to a plurality of error thresholds; and
employing a fault threshold set to identify presence of the subsystem fault and isolate the subsystem fault based upon the signature attributes for all of the subsystem operating signatures.

5. A method for monitoring a subsystem for a vehicle, comprising:
monitoring states of commanded parameters and observed parameters for the subsystem on board the vehicle during ongoing operation;
transmitting the commanded parameters and the observed parameters for the subsystem to a subsystem monitoring system remote from the vehicle;
employing the subsystem monitoring system to:
execute a system model to determine expected states for the observed parameters based upon the commanded parameters,
determine deviations in the observed parameters based upon comparisons of the expected states and the monitored states for the observed parameters,
determine magnitudes of subsystem operating signatures based upon the deviations in the observed parameters,
identify presence of a subsystem fault and isolate the subsystem fault based upon the subsystem operating signatures, and
communicate the presence of the isolated fault to the vehicle.

6. The method of claim 5, wherein employing the remote subsystem monitoring system to determine deviations in the observed parameters based upon comparisons of the expected states and the monitored states for the observed parameters comprises:
executing an off-line analysis employing parametric data representing operation of the subsystem to develop a system model associated with the subsystem;
employing the system model to determine expected states for the observed parameters based upon the commanded parameters; and
determining deviations in the observed parameters based upon comparisons of the expected states and the monitored states for the observed parameters.

7. The method of claim 5, wherein employing the remote subsystem monitoring system to determine magnitudes of subsystem operating signatures based upon the deviations in the observed parameters comprises:
developing a plurality of subsystem operating signatures \hat{T}₁, \hat{T}₂, . . . \hat{T}_{N} associated with the observed parameters;
executing a training algorithm that determines a weighting vector for the subsystem operating signatures \hat{T}₁, \hat{T}₂, . . . \hat{T}_{N} associated with specific faults for the selected subsystem; and
employing the weighting vector for the subsystem operating signatures \hat{T}₁, \hat{T}₂, . . . \hat{T}_{N} and the deviations in the observed parameters to determine said magnitudes of the subsystem operating signatures.

8. The method of claim 5, wherein employing the remote subsystem monitoring system to identify presence of a subsystem fault and isolate the subsystem fault based upon the subsystem operating signatures comprises:
for each of the subsystem operating signatures, identifying a signature attribute based upon a magnitude of the respective subsystem operating signature in relation to a plurality of error thresholds; and
employing a fault threshold set to identify presence of a subsystem fault and isolate the subsystem fault based upon the signature attributes for the subsystem operating signatures.

9. A method for monitoring a returnless fuel subsystem for a vehicle, comprising:
monitoring commanded and observed parameters of the returnless fuel subsystem on-board the vehicle during vehicle operation;
determining deviations in the observed parameters off-board the vehicle;
employing the deviations to determine magnitudes of the returnless fuel subsystem operating signatures off-board the vehicle;
employing the operating signatures to identify and isolate a fault in the returnless fuel subsystem the subsystem fault off-board the vehicle; and
communicating the fault in the returnless fuel subsystem to the vehicle.

10. The method of claim 9, wherein monitoring commanded parameters of the returnless fuel subsystem on-board the vehicle during vehicle operation comprises monitoring a pump voltage command.

11. The method of claim 9, wherein monitoring observed parameters of the returnless fuel subsystem on-board the vehicle during vehicle operation comprises monitoring an electrical current, system pressure, and rotational speed associated with an electrically-powered pump motor of a fuel pump of the returnless fuel subsystem.

12. The method of claim 9, wherein determining deviations in the observed parameters off-board the vehicle comprises:
executing an off-line analysis employing parametric data representing operation of the returnless fuel subsystem to develop a system model associated with the returnless fuel subsystem;
employing the system model to determine expected states for electrical current, system pressure, and rotational speed associated with an electrically-powered pump motor of a fuel pump of the returnless fuel subsystem based upon a commanded pump voltage off-board the vehicle; and
determining deviations in the electrical current, system pressure, and rotational speed of the electrically-powered pump motor of the fuel pump off-board the vehicle based upon comparisons of the expected states and the monitored states for the observed parameters.

13. The method of claim 12, wherein the system model determines the expected state for the electrical current based upon a commanded pump voltage off-board the vehicle in accordance with the following relationship:
Iₘ=aᵢ(V)Pₛ+bᵢ(V)
wherein Iₘ is expected pump current;
Pₛ is system pressure;
V is pump voltage; and
aᵢ and bᵢ are returnless fuel subsystem-specific scalar values.

14. The method of claim 12, wherein the system model determines an expected state for the rotational speed based upon a commanded pump voltage off-board the vehicle in accordance with the following relationship:
ωₘ=a_{ω}(V)Pₛ+b_{ω}(V)
wherein ωₘ is expected pump rotational speed;
Pₛ is system pressure;
V is pump voltage; and
a_{ω} and b_{ω} are returnless fuel subsystem-specific scalar values.

15. The method of claim 12, wherein the system model determines an expected state for the system pressure based upon a commanded parameter of pump voltage off-board the vehicle in accordance with the following relationship:
$${P}_{m} = \frac{{I}_{s} - {b}_{i} ( V )}{{a}_{i} ( V )}$$
wherein Pₘ is the expected system pressure;
Iₛ is the pump current;
V is the commanded pump voltage; and
aᵢ and bᵢ are returnless fuel subsystem-specific scalar values.

16. The method of claim 9, wherein employing the deviations to determine magnitudes of returnless fuel subsystem operating signatures off-board the vehicle comprises:
developing a plurality of returnless fuel subsystem operating signatures \hat{T}₁, \hat{T}₂, and \hat{T}₃ associated with the observed parameters off-line;
executing a training algorithm that determines a weighting vector for the returnless fuel subsystem operating signatures \hat{T}₁, \hat{T}₂, and \hat{T}₃ associated with specific faults for the returnless fuel subsystem; and
employing the weighting vector for the returnless fuel subsystem operating signatures \hat{T}₁, \hat{T}₂, and \hat{T}₃ and the deviations in the observed parameters to determine said magnitudes of the returnless fuel subsystem operating signatures.

17. The method of claim 16, wherein the operating signature \hat{T}₁ is associated with a deviation in an electrical current of an electrically-powered pump motor of a fuel pump of the returnless fuel subsystem, the operating signature \hat{T}₂ is associated with a deviation in the rotational speed of the electrically-powered pump motor of the fuel pump of the returnless fuel subsystem, and the operating signature \hat{T}₃ is associated with a deviation in a system pressure of the returnless fuel subsystem.

18. The method of claim 16, wherein the returnless fuel subsystem operating signature \hat{T}₁ is determined in accordance with the following relationship:
\hat{T}₁=(w₁Iₛ+w₂Q±w₃Pₛ+w₄V+w₅ωₘ_{_}_{obs})(ΔI)
wherein Iₛ is electrical current;
Q is system mass flow;
Pₛ is system pressure;
V is system voltage;
ωₘ_{_}_{obs} is observed motor speed;
ΔI is current deviation; and
w=[w₁ w₂ w₃ w₄ w₅] is a weighting vector determined off-line using linear discrimination analysis to achieve separation between a plurality of returnless fuel subsystem faults.

19. The method of claim 18, wherein the returnless fuel subsystem faults include a pressure sensor bias fault, an in-system fuel leak, a blocked fuel filter, and a fault in the windings or commutator of the electrically-powered pump motor of the fuel pump.
